(19) United States
(12) Patent Application Publication
(10) Pub. No.: US 2018/0142744 A1
(43) Pub. Date: May 24, 2018

(54) Mounting Tool for a Brake Retaining Clip with a Securing Arrangement of a Disc Brake, Disc Brake, and Brake Pad Set

(71) Applicant: KNORR-BREMSE Systeme fuer Nutzfahrzeuge GmbH, Muenchen (DE)

(72) Inventors: Oliver KRAUSE, Wolfratshausen (DE); Matthias KLINGNER, Moorenweis (DE); Michael PESCHEL, Schoengeising (DE); Tobias SCHOEFBERGER, Mainburg (DE)

(21) Appl. No.: 15/874,530

(22) Filed: Jan. 18, 2018

Related U.S. Application Data
(63) Continuation of application No. PCT/EP2016/066851, filed on Jul. 15, 2016.

(30) Foreign Application Priority Data
Jul. 22, 2015 (DE) 10 2015 111 847.5

(51) Int. Cl. F16D 65/00; F16D 65/097; F16D 55/225

(52) U.S. Cl. CPC F16D 65/0043; F16D 2055/002; F16D 55/225; F16D 65/0978

(57) ABSTRACT

A mounting tool for mounting a brake retaining clip to and/or removing the brake retaining clip from a securing arrangement of a disc brake, wherein the securing arrangement has a securing element, which is fixedly connected to a rear-side backing plate of a rear-side brake pad of the associated disc brake and has at least two spring arms. The mounting tool has a base, a spreading device, and a guiding device.

### CROSS REFERENCE TO RELATED APPLICATIONS

This application is a continuation of PCT International Application No. PCT/EP2016/066851, filed Jul. 15, 2016, which claims priority under 35 U.S.C. §119 from German Patent Application No. 10 2015 111 847.5, filed Jul. 22, 2015, the entire disclosures of which are herein expressly incorporated by reference.

### BACKGROUND AND SUMMARY OF THE INVENTION

The present invention relates to a mounting tool for mounting pad retaining clips with respect to a securing apparatus of a disc brake. The invention also relates to a disc brake and to a brake pad set for a disc brake.

Brake pads of disc brakes, in particular pneumatic disc brakes, in vehicles, for example commercial vehicles, are held in so-called pad slots by way of a pad retaining clip. In order that the pad retaining clip cannot be displaced out of its position by lateral forces in the vehicle, additional components are required which prevent not only a displacement of the retaining clip, in particular during operation, but also permit mounting and dismounting.

These additional components include, for example, combinations of bolts and securing splints, spring elements and screws. After the insertion of the brake pads and mounting of the brake pad clip, it may be the case that a technician thereafter forgets to attach the components for securing purposes. Securing of the pads is thus realized only for an indefinite length of time; the error is inevitably not obvious. In the worst case, the pad retaining clip may under some circumstances slip during operation and impair a securing action of the brake pads.

Numerous proposals have been made for such securing components and securing apparatuses. One example, for illustration, is presented by document DE 102005045877 B3; a further example is described in document DE 202008013446 U1.

There is a constant demand for simplified mounting and simplified dismounting, and therefore shortened mounting and servicing times.

The invention is based on the problem of providing an easily handlable mounting and dismounting tool.

It is a further object to protect the pad set with the associated securing element during transportation, during handling and in the operating state. In particular, the tool is intended to prevent the securing element from not being plastically deformed. A further object consists in providing an improved disc brake.

It is a further object to provide an improved brake pad set for a disc brake.

The invention achieves this and further objects by way of a mounting tool according to the invention for the mounting and/or dismounting of a pad retaining clip on a securing apparatus of a disc brake. The securing apparatus has a securing element which is fixedly connected to a rear-side pad carrier plate of a rear-side brake pad of the associated disc brake, which securing element has at least two spring arms. The mounting tool has a base, a spreading device and a guide device.

Simple and fast mounting of a pad retaining clip on the securing apparatus is thus made possible. The mounting tool has a compact construction with a base to which the spreading device and the guide device are attached. It is thus advantageously possible, during a spreading process of the spring arms of the securing apparatus, for the mounting tool to be simultaneously guided, which yields simple and fast mounting and dismounting.

During the mounting and dismounting, the tool has a defined spacing, which determines the extent to which the securing element is intended to be, or can be, spread. Without the tool, it would be possible for the securing element to be spread too far, and thus plastically deformed, during the mounting and dismounting.

In one embodiment, the base has a base plate to which two finger plates with in each case, one bevel are attached and form the spreading device. This construction is advantageously compact. No additional tools or auxiliary means are required.

A further embodiment provides that the guide device comprises two fingers with, in each case, one oblique surface, wherein the two fingers are arranged on the base plate above the two finger plates. In this way, it can advantageously be realized that, during a spreading process by way of the spreading device, the mounting tool is simultaneously guided by the guide device on an end section of the pad retaining clip to be mounted. By way of oblique surfaces which serve for guidance, it is furthermore the case that correct positioning of the mounting tool is simultaneously realized.

For this purpose, it is advantageous for the oblique surfaces to point toward the two finger plates; this yields a compact and expedient construction.

In an alternative embodiment, the guide device has in each case one horizontal guide on in each case one plate section. An advantageously simple and effective guide is formed in this way.

In a yet further embodiment, the mounting tool furthermore has a retaining device. By way of said retaining device, a functionality of the mounting tool is advantageously expanded. The mounting tool can thus be applied to the securing element of the securing apparatus on the brake pad in a protective position as a protective element for storage, transportation and shipping. This makes it considerably easier for the brake pads with the securing elements attached thereto to be stacked. Damage to the securing elements, and damage caused by said securing elements, can be considerably reduced.

In one embodiment, for this purpose, the retaining device has in each case one inner longitudinal wall and one outer longitudinal wall with, in each case, one receptacle. The mounting tool can thus be easily mounted as a protective element onto the spring arms of the securing element.

Here, in each case one inner longitudinal wall and in each case one outer longitudinal wall on each longitudinal side of the base plate are arranged in each case parallel to one another with a spacing, wherein the, in each case, one receptacle is arranged between the one inner longitudinal wall and the one outer longitudinal wall. This construction offers the advantage that stiffening of the mounting tool is realized simultaneously with the increased functionality.

In an alternative embodiment, the base has a transverse member to which two plate sections with, in each case, one bevel are attached and form the spreading device. This construction is advantageously compact and simple.

A particular advantage of a compact construction is obtained if the guide device comprises one side wall with guide sections which are each attached to a plate section.

In another embodiment, the mounting tool furthermore has a retaining device, by way of which said mounting tool can be attached advantageously easily to the securing element.

If the retaining device is formed from the guide device with the side walls with guide sections, a particular advantage of multiple functionality is attained.

Alternatively, the retaining device may have abutments and axial guides, which are particularly easy to produce on the mounting tool and permit an effective function.

A disc brake according to the invention for a vehicle, in particular for a commercial vehicle, comprises a brake disc with a brake disc axis of rotation, a brake caliper, in particular a sliding caliper, with an application section and a rear section, and at least two brake pads with in each case one pad rear plate equipped with a pad retaining spring. The brake pads are supported in each case under the preload of a pad retaining clip detachably fastened to the brake caliper. An application-side brake pad is assigned to the application section and a rear-side brake pad is assigned to the rear section. A securing apparatus secures the position of the pad retaining clip, wherein the securing apparatus has a securing element which is fixedly connected to the rear-side pad carrier plate of the rear-side brake pad and which has two spring arms which engage with in each case one end section of the pad retaining clip. The securing element of the securing apparatus is equipped with the abovedescribed alternative mounting tool.

Since the mounting tool can remain both as a mounting tool and as a protective element on the securing apparatus, said mounting tool is captively retained. Mounting is particularly advantageously straightforward, because no removal, only a pulling-out and pushing-back action, is necessary.

A brake pad set is provided according to the invention for a disc brake for a vehicle, in particular for a commercial vehicle. The disc brake has a brake disc with a brake disc axis of rotation, a brake caliper, in particular a sliding caliper, with an application section and a rear section, at least two brake pads with in each case one pad rear plate equipped with a pad retaining spring. The brake pads are supported in each case under the preload of a pad retaining clip detachably fastened to the brake caliper. An application-side brake pad is assigned to the application section and a rear-side brake pad is assigned to the rear section. A securing apparatus secures the position of the pad retaining clip. The securing apparatus has a securing element which is fixedly connected to the rear-side pad carrier plate of the rear-side brake pad and which has two spring arms which engage with in each case one end section of the pad retaining clip. The brake pad set includes the two brake pads on their respective pad rear plates, the associated pad retaining springs, the pad retaining clip, the securing apparatus and the at least one mounting tool as described above.

Exemplary embodiments of a mounting tool according to the invention, of a disc brake according to the invention and of a brake pad set according to the invention are illustrated in the drawings and will be described in more detail below, with further advantages of embodiments according to the invention also being discussed.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic perspective view of a disc brake with a securing apparatus.

FIG. 2 shows a schematic sectional view of the securing apparatus in a y-z plane of a brake disc axis.

FIG. 3 shows a schematic perspective view of a first exemplary embodiment of a mounting tool in interaction with the securing element as per FIG. 2.

FIG. 4 shows a schematic perspective view of the first exemplary embodiment of the mounting tool as per FIG. 3 in a protective position.

FIG. 5 shows a schematic perspective view of a second exemplary embodiment of the mounting tool in interaction with the securing element as per FIG. 2.

FIG. 6 shows a schematic perspective view of the second exemplary embodiment of the mounting tool as per FIG. 5 in a protective position.

FIG. 7 shows a schematic perspective view of a third exemplary embodiment of the mounting tool in a protective position.

FIG. 8 shows a schematic perspective view of the third exemplary embodiment of the mounting tool as per FIG. 7 in a mounting/dismounting state.

FIG. 9 shows a schematic perspective view of a disc brake with a securing apparatus and the third exemplary embodiment of the mounting tool as per FIG. 7.

FIG. 10 shows a schematic perspective view of the securing apparatus with the third exemplary embodiment of the mounting tool as per FIG. 9 in a protective position.

FIG. 11 shows a schematic perspective view of the third exemplary embodiment of the mounting and dismounting tool as per FIG. 9 and FIG. 10.

Below, expressions such as “top”, “bottom”, “right”, “left” etc. are used, which relate to the orientations in the figures. Coordinates x, y, z in the figures serve for further orientation.

### DETAILED DESCRIPTION OF THE DRAWINGS

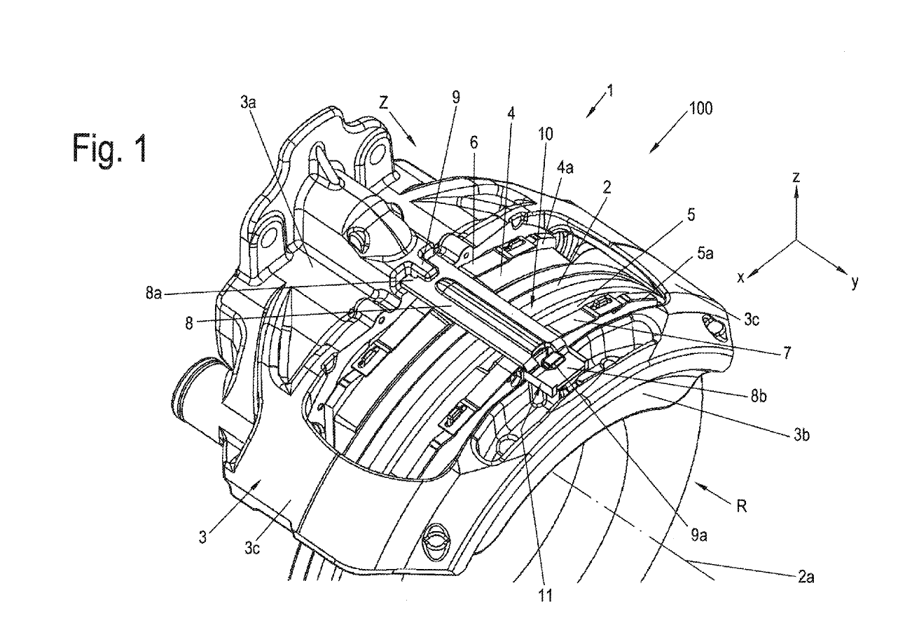

FIG. 1 shows a schematic perspective view of a disc brake 1, for example a pneumatic disc brake 1, having a securing apparatus 10 for the locking of a pad retaining clip 8.

The disc brake 1 is assigned for example to a vehicle, in particular commercial vehicle, and includes a brake disc 2 with a brake disc axis of rotation 2a running in this case in a y direction, a brake caliper 3, a brake carrier (not shown in any more detail), and at least two brake pads 4 and 5, which are applied in each case to a pad rear plate 4a, 5a. The brake pads 4 and 5 are received in the brake carrier in so-called pad slots and are held by way of a pad retaining clip 8, which will be described in more detail below.

The brake caliper 3 is in this case in the form of a sliding caliper, is held (in a manner not described in any more detail) on the brake carrier which is fixed so as to be positionally static, and has an application section 3a and a rear section 3b. These sections 3a, 3b are connected to one another in the y direction at both ends in the y direction by way of connecting sections 3c. Here, the application section 3a and the rear section 3b are arranged in each case on one side of the brake disc 2 and parallel thereto, wherein the connecting sections 3c extend in the y direction parallel to the brake disc axis of rotation 2a. The application section 3a and the rear section 3b form, together with the connecting sections 3c, an opening over the brake disc 2 with the brake pads 4 and 5, for access to the brake pads 4 and 5 during mounting, exchange and maintenance work.

The application section 3a of the brake caliper 3 accommodates an application mechanism of the disc brake 1. The application mechanism serves for the actuation of the disc brake 1 and may, for example, be a brake rotary lever operated via a compressed-air cylinder, which will however not be discussed in any more detail here.

That side of the disc brake 1 on which the application section 3a of the brake caliper 3 with the application mechanism is arranged will hereinafter be referred to as application side Z. The other side of the disc brake 1, on which the rear section 3b of the brake caliper 3 is arranged, will hereinafter be referred to as rear side R, also referred to as reaction side. These expressions “application side” and “rear side” and further designations relating to these are customary and serve for better orientation.

Accordingly, the brake pad 4 with the pad rear plate 4a which is situated on the application side Z is referred to as application-side brake pad 4, and the opposite brake pad is referred to as rear-side brake pad 5 with the pad rear plate 5a.

During braking processes, the application-side brake pad 4 is acted on by the application mechanism with an application force in the y direction. The rear-side brake pad 5 is received in the rear section 3b of the brake caliper 3 and, in the case of this disc brake 1 with the brake caliper 3 of sliding-caliper design, does not perform any relative movements relative to the rear section 3b.

The brake pads 4 and 5 are each equipped, on the top sides of their respective pad rear plate 4a, 5a, with a pad retaining spring 6, 7, which pad retaining springs interact with the pad retaining clip 8. The pad retaining clip 8 extends in the y direction across the opening formed over the brake disc 2 by the application section 3a, by the rear section 3b and by the connecting sections 3c. The pad retaining clip is arranged over the installed brake pads 4, 5 so as to press against the top sides of the pad retaining springs 6, 7, and thus serves for securing the brake pads 4, 5 in the brake carrier. Here, the pad retaining clip 8 is received with an application-side end section 8a in a bearing section 9 of the application section 3a of the brake caliper 3, wherein an opposite end section 8b of the pad retaining clip 8 is connected to a retaining section 9a of the rear section 3b of the brake caliper 3.

The pad retaining clip 8 is connected to the bearing section 9 and to the retaining section 9a and is equipped with a securing apparatus 10 such that the pad retaining clip firstly cannot be displaced in its installed position, for example by acting lateral forces, and secondly can be mounted and dismounted. The securing apparatus 10 is in this case arranged in the region of the rear-side brake pad 5 and has a securing element 11 which will be discussed in more detail further below.

The reference designation 100 denotes a brake pad set which comprises the two brake pads 4, 5 on respective pad rear plates 4a, 5a, the associated pad retaining springs 6, 7, the pad retaining clip 8 and the securing apparatus 10.

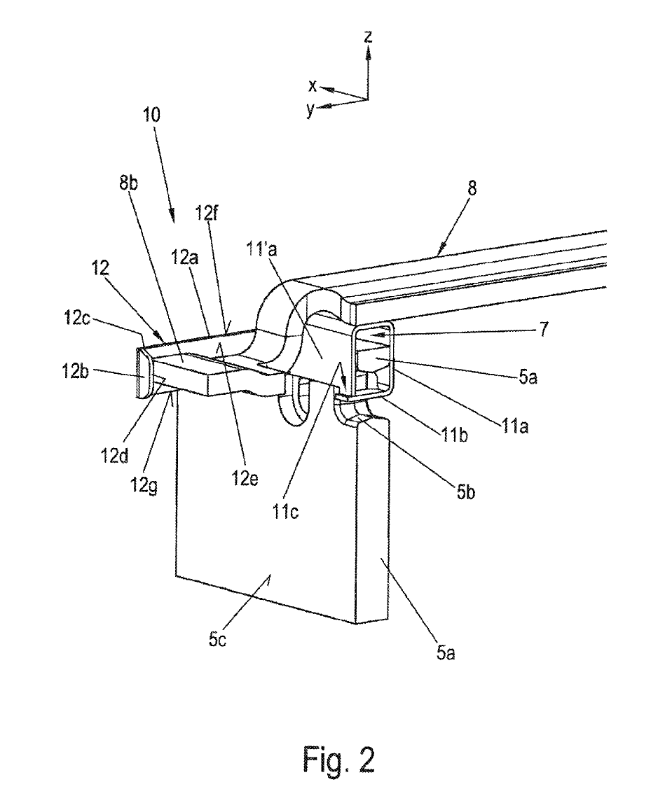

FIG. 2 illustrates a schematic sectional view of the securing apparatus 10 in a y-z plane of the brake disc axis 2a.

The securing apparatus 10 has the securing element 11, which is arranged with a body 11a of sleeve-shaped form around the upper edge of the pad rear plate 5a. A section 11b of the body 11 a extends through an opening 5b of the pad rear plate 5a in such a way that the end section of said section projects outward through the opening 5b from a rear side 5c of the pad rear plate 5a and is fixedly connected, for example welded, to an externally situated section of the body 11a, specifically to a face plate 11′a, at a connection 11c.

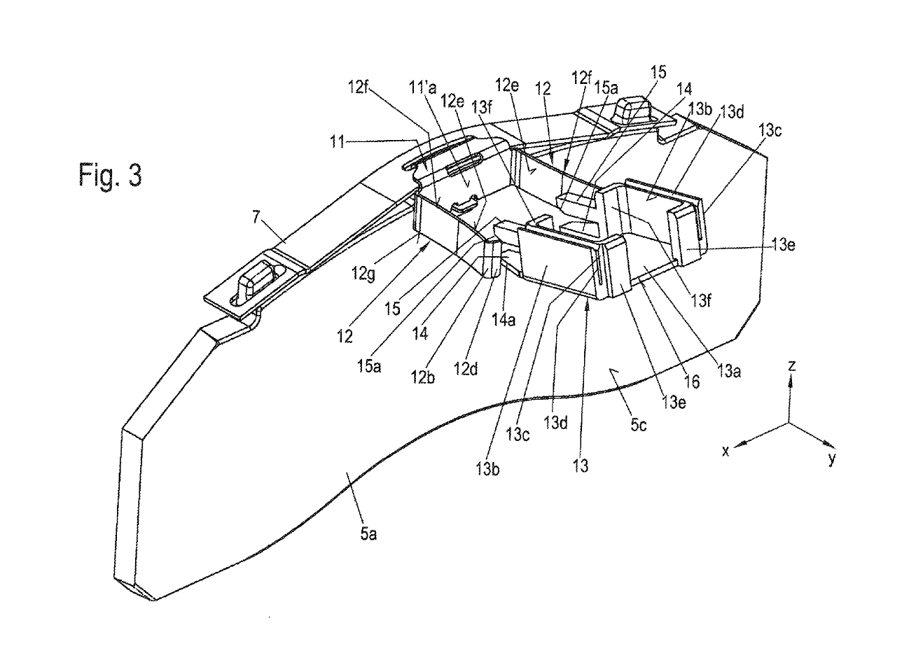

The body 11a and the face plate 11′a surround the upper edge region of the pad rear plate 5a, wherein the pad retaining spring 7 which is arranged on the edge of the pad rear plate 5a is also surrounded. This is indicated by the reference designation 7 and can be understood from the further FIGS. 3 to 6.

On the face plate 11′a of the securing element 11, on both sides, there is integrally formed in each case one spring arm 12 with a lug section 12a. FIG. 2 shows only one of said oppositely situated lug sections 12a, wherein the other is easily conceivable in conjunction with FIG. 1 and FIG. 3. Thus, the following description applies to both lug sections 12a.

On each free end of a respective lug section 12a there is integrally formed in each case one lug 12b, which is bent through 90°. Said lugs 12b are bent in each case toward the brake disc axis of rotation 2a so as to be arranged mirror-symmetrically with respect to the y-z sectional plane of FIG. 2. This can also be seen from FIGS. 1 and 3.

The lug section 12a runs in a y-z plane and extends in the positive y direction, wherein said lug section bears against a section of the end section 8b of the pad retaining clip 8. The lug 12b lies in an x-z plane and surrounds a corner of the end section 8b.

The lug section 12a has an upper longitudinal edge 12f and a lower longitudinal edge 12g parallel to said upper longitudinal edge. The lug 12b is equipped with bevels 12c, which may also be rounded. Finally, the lug 12b has a face edge 12d which runs in a z direction. The face edges 12d of both lugs 12b are situated mirror-symmetrically opposite one another, as can be seen from the other figures.

During the mounting of the pad retaining clip 8, the spring arms 12 of the securing element 11 are, by way of a mounting tool 13, 18, moved apart from one another in an x-y plane, that is to say spread with a defined spacing such that the spring element is not plastically deformed, or the spring arms 12 do not plastically deform, and such that the pad retaining clip 8 can be inserted in the brake caliper 3. The spring arms 12 remain preloaded in the spread position by way of the mounting tool 13, 18. After the pad retaining clip 8 has been inserted into its end position, the mounting tool 13, 18 is removed again. Here, the spring arms 12 spring back into their original position again. The spring arms 12 are now unloaded and are not subjected to load during operation. In this way, sagging of the spring arms (for example under the action of temperature) can be avoided. The lug sections 12a with the lugs 12b which engage around the corners of the end section 8b of the pad retaining clip prevent a displacement of the pad retaining clip 8 in the direction of the brake disc axis of rotation 2a, that is to say in the y direction. The pad retaining clip is thus secured.

For the dismounting, the spring arms 12 are spread again by way of the mounting tool 13, 18 until the engaging-around lugs 12b release the end section 8b of the pad retaining clip 8. The spring arms 12 must be held in the stressed position until the pad retaining clip 8 has been displaced a sufficient distance during the dismounting process.

The spring arms 12 are spread by way of the respective mounting tool 13, 18. Here, the face edges 12d of the lugs 12b interact, by contact, with the respective mounting tool 13, 18. Furthermore, the mounting tool 13, 18 is guided in a suitable manner.

The mounting tool 13, 18 may furthermore be used as a protective element in a protective position.

The mounting tool 13, 18 comprises a base, a spreading device, a guide device and a retaining device. The base serves as a carrier of the spreading device, guiding device and retaining device. The spreading device is used for spreading the spring arms, wherein the guide device forms a guide for the mounting tool during the mounting/dismounting. By way of the retaining device, the mounting tool can be retained in the protective position.

Two exemplary embodiments of mounting tools 13, 18 will be described below.

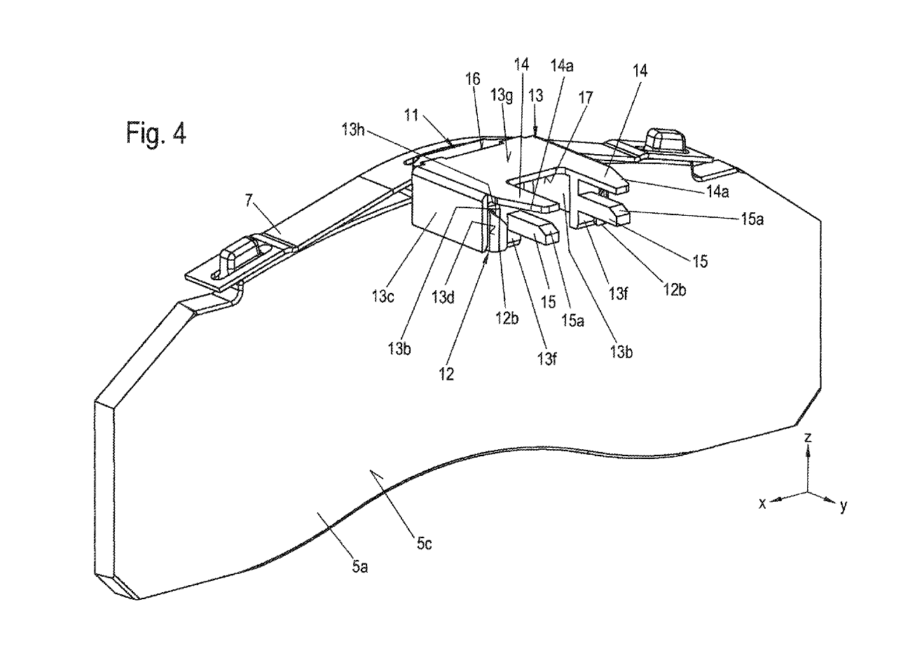

In this regard, FIG. 3 shows a schematic perspective view of a first exemplary embodiment of the mounting tool 13 in interaction with the securing element 11 as per FIG. 2. FIG. 4 illustrates a schematic perspective view of the first exemplary embodiment of the mounting tool 13 as per FIG. 3 in a protective position.

FIG. 3 illustrates the rear plate 5a of an exemplary brake pad 5 of the brake pad set 100 with the securing apparatus 10. The securing element 11 is fastened to the pad rear plate 5a as described above.

The mounting tool 13 has two functions. A first function consists in that the mounting tool 13 is, in a protective position, mounted onto the spring arms 12 of the securing element 11 and forms a protector. This is illustrated in FIG. 4. In said protective position, the mounting tool 13 securely retains the spring arms 12 of the securing element 11 and protects these against bending, for example during packaging, transportation, unpacking and storage. Furthermore, by way of said protective function, it is expediently made possible for the rear-side brake pads 5 to be stacked.

A second function consists in that the mounting tool 13 can be utilized for the mounting and dismounting of securing apparatus 10 and pad retaining clip 8.

For the use of the mounting tool 13 for mounting purposes, said mounting tool is removed from the protective position (FIG. 4) and is used as described below.

The mounting tool 13 comprises a base plate 13a, two inner longitudinal walls 13b with two outer longitudinal walls 13c and with a respective receptacle 13d in between, two finger plates 14, and two fingers 15.

The base plate 13a is of rectangular form and, in this case, lies in an x-y plane. The base plate 13a forms the base. On the longitudinal sides, running in the y direction, of the base plate 13a, there is integrally formed in each case one inner longitudinal wall 13b with an outer longitudinal wall 13c. The inner longitudinal wall 13b and the outer longitudinal wall 13c lie in y-z planes perpendicular to the base plate 13a, and project in the z direction from a surface of the base plate 13a. The other surface of the base plate 13a forms an outer surface 13g (see FIG. 4).

The inner longitudinal wall 13b and the outer longitudinal wall 13c are arranged parallel to one another with a spacing and are connected at their lower longitudinal sides. Here, the respective receptacle 13d is formed between an inner longitudinal wall 13b and an outer longitudinal wall 13c. The receptacle 13d is upwardly open and has longitudinally running bevels at said opening.

The inner longitudinal wall 13b and the outer longitudinal wall 13c form, together with the receptacle 13d, the retaining device.

Each inner longitudinal wall 13b is connected, at each end, to a lug-like post 13e, 13f and, together with the lug-like posts 13e, 13f, forms a U-shaped wall. The posts 13e, 13f are integrally formed, in each case on a transverse side of the base plate 13a, at right angles to the longitudinal sides and extend in each case in the x direction over a width which in this case corresponds in each case to approximately one quarter of the length of a transverse side. The height of the posts in the z direction corresponds to a height of the inner longitudinal walls 13b and outer longitudinal walls 13c in the z direction. Said heights in turn have a dimension which is at least as large as a dimension of a lug section 12a of the securing element 11 in the z direction.

A free face edge 16 of one transverse side of the base plate 13a runs between the lower ends of the posts 13e. In the same way, a free face edge 17 of the other transverse side of the base plate 13a is arranged between the lower ends of the other posts 13f.

The base plate 13a is, in each case at a lower end of a respective post 13f, elongated in the y direction so as to form a finger plate 14. A width of a finger plate 14 in the x direction corresponds to the width of a post 13f. A length of a finger plate 14 in the y direction corresponds approximately to one third of a length of the base plate 13a in the y direction. A thickness of a finger plate 14 corresponds to the thickness of the base plate 13a. At their lateral outer edges, the finger plates 14 have in each case one bevel 14a. Each bevel 14a extends from the respective free end of a finger plate 14 as far as the other end of said finger plate attached to the base plate 13a.

The finger plates 14 with the bevels 14a form the spreading device.

On the outer sides of the posts 13f, at approximately one third of the height thereof, there is integrally formed in each case one finger 15 which extends in the y direction. Each finger 15 has a square cross section and is provided, on its respective free end, with an oblique surface 15a. The oblique surfaces 15a point toward the finger plates 14.

Each finger 15 extends in the y direction parallel to an associated finger plate 14 and has the same length as said finger plate 14 in the y direction.

The fingers 15 with the oblique surfaces 15a form the guide device.

The posts 13e, 13f serve for stiffening purposes, wherein the posts 13f form carriers for the fingers 15 of the guide device.

FIG. 3 shows the mounting tool 13 in a mounting position. Here, the inner longitudinal walls 13b and the outer longitudinal walls 13c point upward. The narrow free ends of the finger plates 14 are mounted between the lugs 12b of the spring arms 12 of the securing element 11 such that the fingers 15 are arranged above the lugs 12b. Here, the mounting tool 13 is angled slightly, that is to say the plane of the base plate 13a lies at an angle with respect to the x-y plane of the securing element 11. For this purpose, the oblique surfaces 15a of the fingers 15 on the surface of the end section 8b of the pad retaining clip 8 serve as a guide for the mounting tool 13 and predefine the angle at which the mounting tool 13 must be held. The face edges 12d of the lugs 12b are in each case in contact with the start of the bevels 14a of the finger plates 14 at the free ends thereof.

A movement of the mounting tool 13 in the y direction toward the securing element 11 has the effect that, by means of the bevels 14a of the finger plates 14, the face edges 12d which are in contact with said bevels, and thus the lugs 12b with the spring arms 12 of the securing element 11, are forced apart to such an extent that the end section 8b of the pad retaining clip 8 can be inserted as per FIG. 2. A pulling-back action of the mounting tool 13 allows the spring arms 12 to spring back into their initial position again, wherein the corners of the end section 8b of the pad retaining clip 8 are engaged around as shown in FIG. 2.

During the dismounting process, which can be seen in conjunction with FIG. 1, the finger 15 surrounds the pad retaining clip 8b from above. The finger plate 14 surrounds the pad retaining clip 8b from below. The bevels 14a open the securing element to a defined extent (in this regard, see also FIG. 4, detent surface 13h). Thereafter, the pad retaining clip 8 is removed with the tool.

FIG. 4 illustrates the protective position of the mounting tool 13. Here, the mounting tool 13 has been applied to the spring arms 12 of the securing element 11 such that a respective lug section 12a of a spring arm 12 is received in in each case one receptacle 13d between an inner longitudinal wall 13b and an outer longitudinal wall 13c and bears by way of its upper longitudinal edge 12f against the base of the receptacle 13d. The base of each receptacle 13d is formed by the connection between inner longitudinal wall 13b and outer longitudinal wall 13c. The bevels at the openings of the receptacles 13d serve to make it easier for the lug sections 12a to be threaded into the respective receptacle 13d.

In the protective position of the mounting tool 13, the lugs 12b are in contact by way of their inner sides with the outer sides of the posts 13f.

In the protective position, the mounting tool 13 is arranged such that the finger plates 14 and the fingers 15 project from the rear side 5c of the pad rear plate 5a. Here, the base plate 13a lies with its outer surface 13b pointing upward, that is to say the spring arms 12 of the securing element 11 and the intermediate space between the spring arms 12 are completely covered and protected by the mounting tool 13.

If the pad falls onto the floor, or is jolted in some other way, the force can be absorbed by the fingers 15 and introduced by the posts directly into the body 11a, wherein the body 11a in turn bears against the pad rear plate 5a.

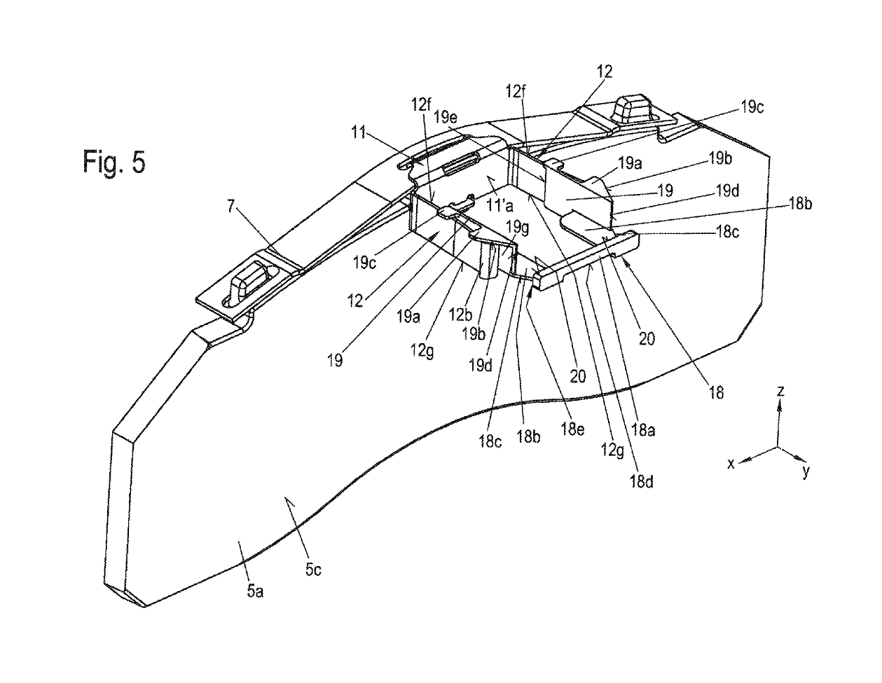

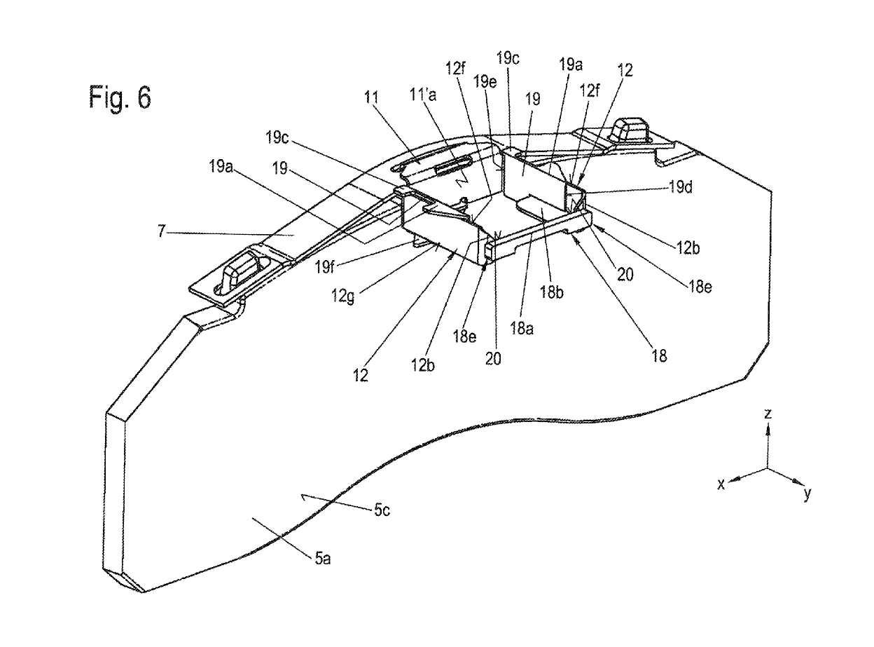

FIG. 5 shows a schematic perspective view of a second exemplary embodiment of the mounting tool 18 in interaction with the securing element 11 as per FIG. 2 during the mounting process. FIG. 6 shows a schematic perspective view of the second exemplary embodiment of the mounting tool 18 as per FIG. 5 in a protective position.

The second exemplary embodiment of the mounting tool 18 also has the two above-described functions, protector and mounting tool, of the first exemplary embodiment of the mounting tool 13.

The mounting tool 18 is constructed differently to the first exemplary embodiment and comprises a transverse member 18a and two strip-like plate sections 18b with in each case one side wall 19 integrally formed thereon at right angles, said side wall having respective guide sections 19a, 19c and 19f.

The transverse member 18a is in the form of a bar with a rectangular cross section. In the middle, said transverse member has an elongate recess 18d on its underside. In each case one strip-like plate section 18d is attached to the ends of said transverse member. Each plate section 18d extends in an x-y plane as an elongate rectangle in the y direction and is, at its ends attached to the transverse member 18a, provided in each case with a bevel 18c on its outer side. The bevels 18c run in each case from outside to inside on the respective connection end of the plate section 18d at the transverse member 18a. Here, at each end of the transverse member 18a, a spacing 18e is provided from each end to the start of the respective connection end.

In the case of this mounting tool 18, the transverse member 18 forms the base.

To each outer longitudinal side of a plate section 18b, there is attached in each case one side wall 19 which projects from the plate section 18b vertically upward in the z direction. Here, each side wall 19 is attached such that a respective end is, with a face edge 19, spaced apart from an abutment surface 20 of the transverse member 18 by the length of a bevel 18c. In other words, each side wall 19 is attached to a straight outer edge of a plate section 18b. Here, a connection between an inner side of a side wall 19 and a straight outer edge of a plate section 18b extends approximately over half of the length of a side wall 19 in the longitudinal direction thereof.

On the upper edge of each side wall 19, there are arranged two guide sections 19a and 19c. Parallel thereto, on the lower edge of each side wall 19, there is integrally formed a further guide section 19f. The guide sections 19a, 19c and 19f lie in x-y planes perpendicular to the side walls 19, wherein the guide sections 19a and 19c run in a common x-y plane which is arranged parallel to the x-y plane of the guide section 19f The guide sections 19a have in each case one bevel 19b which runs outward from the respective face edge 19d. A guide section 19c is arranged in each case on a free end of a side wall 19 and is spaced apart from the guide section 19a in the y direction. In the y direction, the lower guide section 19f lies approximately in the middle between the upper guide sections 19a and 19c.

Here, the side walls 19 with the guide sections 19a, 19b and 19f form the guide device. At the same time, the guide sections 19a, 19b and 19f also form the retaining device.

Here, the spreading device is also formed by the side walls 19 with the plate sections 18b and the bevels 18c.

During the mounting process, the mounting tool 18 is inserted with the side walls 19 between the spring arms 12 such that the face edges 12d of the lugs 12b are in contact with the outer surfaces of the side walls 19 and are forced apart from one another. The bevels 18c open the securing element up to a defined resistance—see FIG. 5, detent surface 19g. The side walls 19 of the mounting tool 18 are guided on the lug sections 12a of the spring arms 12 of the securing element 11 by the guide sections 19a, 19c, 19f. The pad retaining clip 8 can be inserted.

It is however also possible for said mounting tool 18 to be able to remain in its pushed-in position, because said mounting tool does not obstruct the end section 8b of the pad retaining clip 8. This is because, in said pushed-in position of the mounting tool 18 between the spring arms 12, the spring arms 12 can also spring back into their initial position. This is made possible by virtue of the fact that the lugs 12b of the spring arms 12 can engage, behind the face edges 19b of the side walls 19, into the respective bevel 18c of the associated plate section 18b. Then, the abutment surface 20 of the transverse member 18a bears against the lugs 12b (FIG. 6).

The pushed-in position of the mounting tool 18 is thus also the protective position shown in FIG. 6. The side walls 19 and the plate section 18b protect the spring arms against bending during transportation, during handling and in the operating state. The transverse member 18a protects against jolts; said transverse member introduces the force via the face edge 19e into the face plate 11a and into the pad rear plate. In other words, during the mounting of the pad retaining clip 8, the protective position of the mounting tool on the brake pad 5 is changed into the mounting position by pulling the mounting tool 18 out. The pad retaining clip 8 is inserted. Then, the mounting tool 18 is pushed back into its initial position, which was previously the protective position. The pad retaining clip 8 is now locked, that is to say is secured by way of the securing apparatus 10.

Thus, the mounting tool 18 needs to be initially pulled out of its protective position only to such an extent that the spring arms 12 are spread. This is realized by virtue of the fact that, during the pulling-out process, the lugs 12b come into contact by way of their face edges 12d with the respective bevel 18c of a plate section 18b and are then forced outward, and furthermore remain spread against the side walls 19. The pad retaining clip 8 is then inserted in the conventional manner. The mounting tool 18 is pushed back into its initial position, that is to say into the protective position, again. Said mounting tool can thus always remain on the securing element 11, and is captively retained.

The mounting tools 13, 18 may be produced from a suitable plastic. For example, through the use of DuPont Vespel, use up to 500° C. is possible. A metallic material or a combination of different materials is self-evidently also possible.

In a preferred exemplary embodiment, the mounting tool 13 is manufactured from plastic, and the mounting tool 18 is manufactured from a metallic material. Since the mounting tool 18 remains on the pad, it is exposed to relatively high temperatures, which restrict the selection of the material used.

The brake pad set 100 comprises the two brake pads 4, 5 on respective pad rear plates 4a, 5a, the associated pad retaining springs 6, 7, the pad retaining clip 8, the securing apparatus 10 and at least one mounting tool 13, 18. The brake pad set 100 can be used in all disc brakes 1 with a sliding caliper, in particular for commercial vehicles.

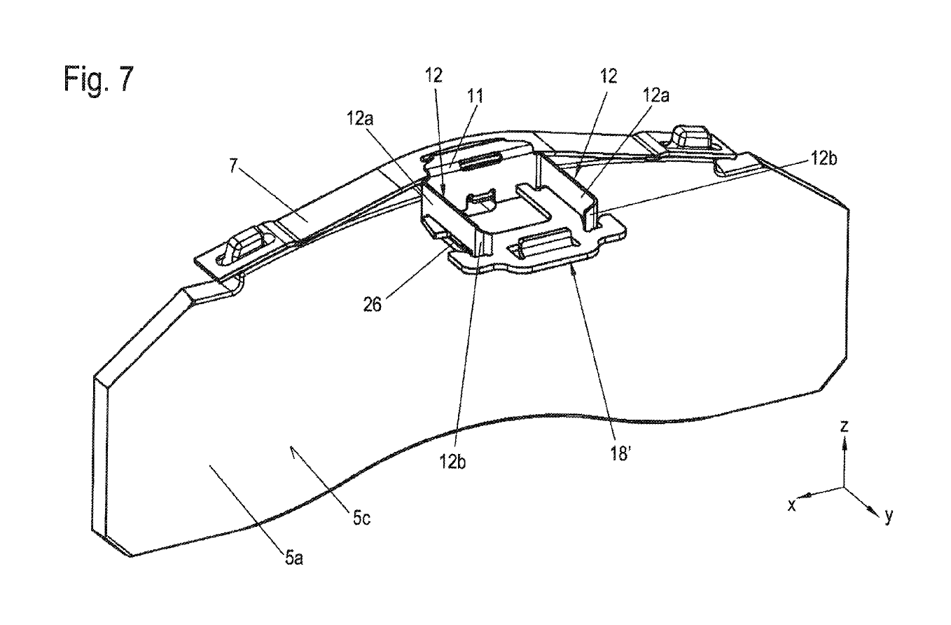

FIG. 7 shows a schematic perspective view of a third exemplary embodiment of the mounting tool 18′ in a protective position.

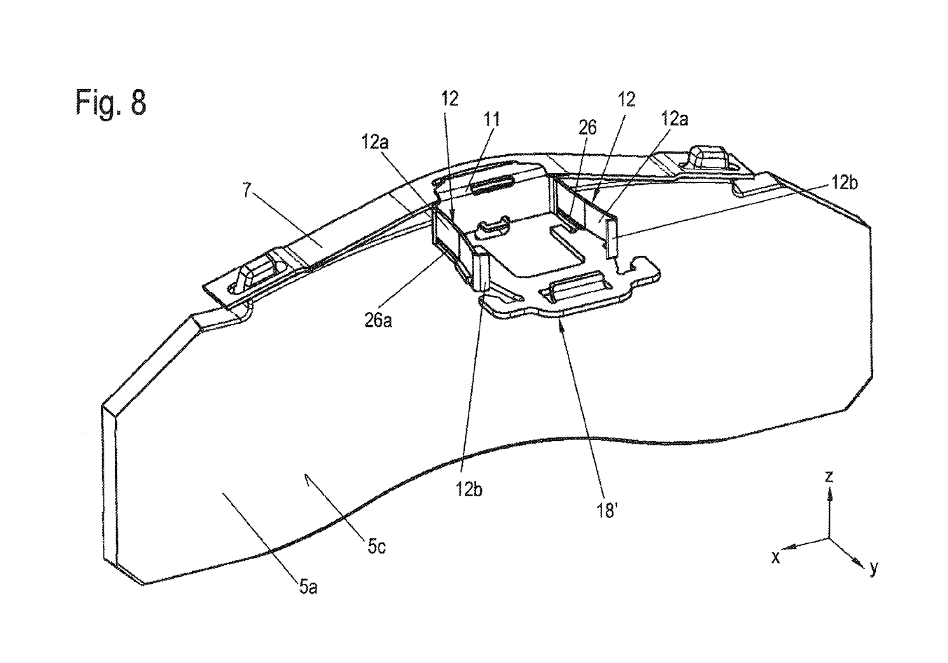

FIG. 8 shows a schematic perspective view of the third exemplary embodiment of the mounting tool 18′ in a mounting/dismounting state.

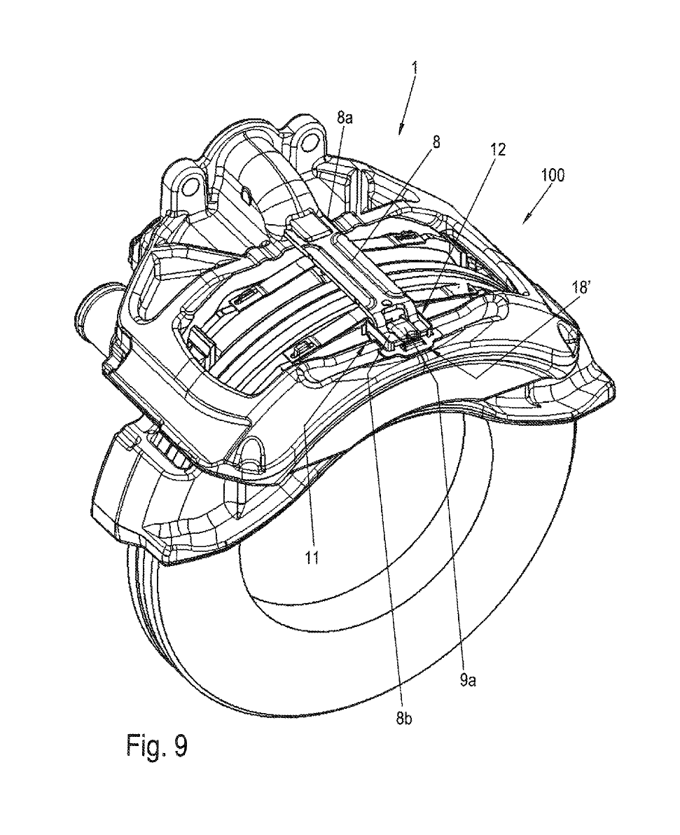

FIG. 9 shows a schematic perspective view of a disc brake 1 with a securing apparatus 11 and with the third exemplary embodiment of the mounting tool 18′ as a mounting/dismounting tool.

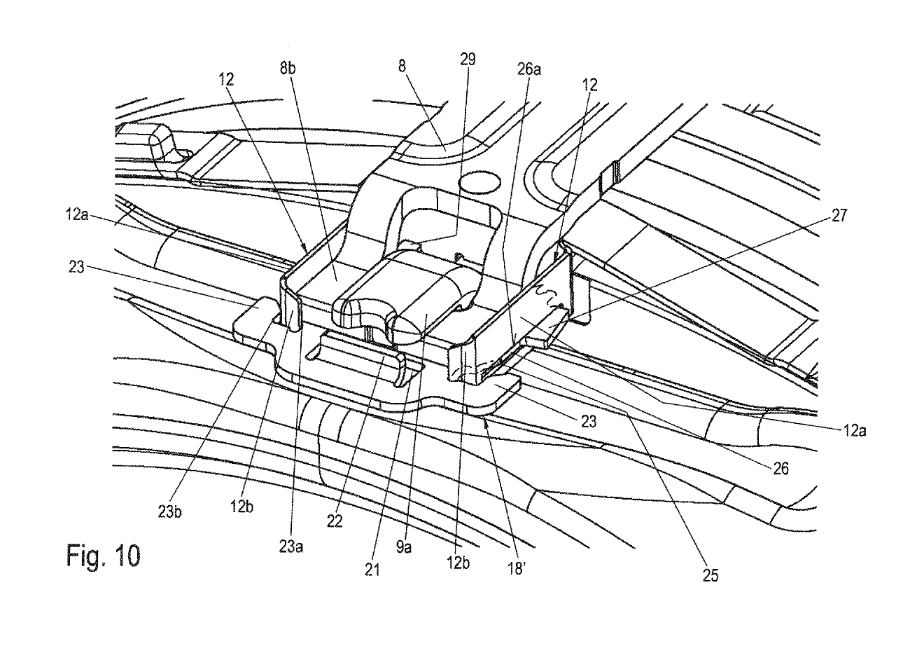

FIG. 10 shows a schematic perspective view of the securing apparatus 11 with the third exemplary embodiment of the mounting tool 18′, as a mounting/dismounting tool as per FIG. 9, in a protective position.

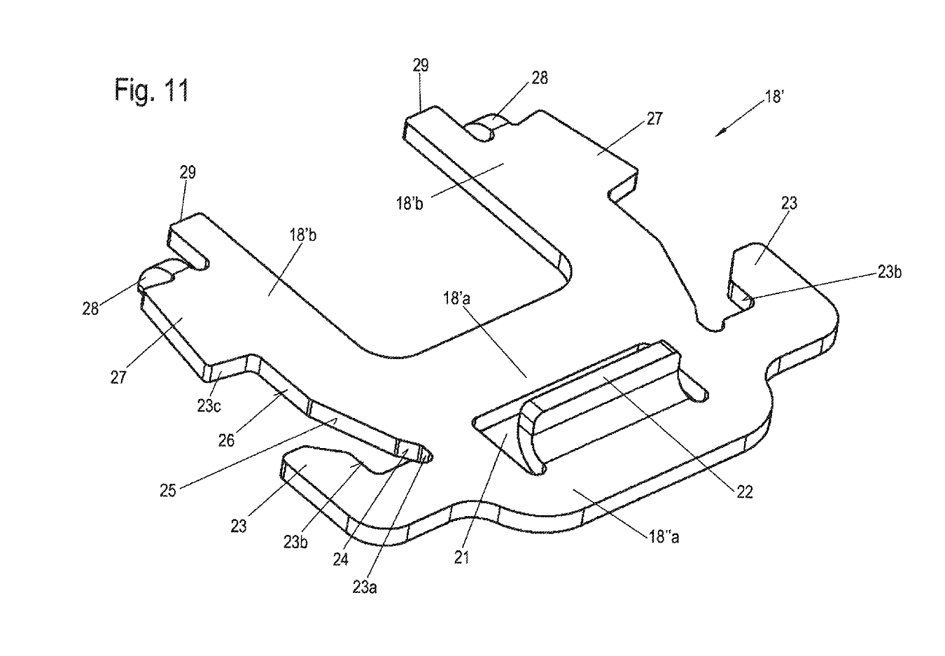

FIG. 11 shows a schematic perspective view of the mounting and dismounting tool 18 as per FIG. 9 and FIG. 10. The mounting and dismounting tool is in the form of a clamp. It is thus possible for the tool 18 to be manufactured from sheet metal. The tool 18 is of symmetrical construction.

The third exemplary embodiment of the mounting tool 18′ has a transverse member 18′a on which, similarly to the second exemplary embodiment, in each case one plate section 18′b is integrally formed at both ends.

In front of the transverse member 18′a there is attached a further transverse member 18″a which, at its ends, is equipped with in each case one hook section 23 which extends rearward (in the negative y direction).

In the middle of the second transverse member 18″a there is formed a cutout 21, at the front side of which a lug 22 is formed so as to be bent upward.

The lug 22 facilitates the dismounting by way of an auxiliary tool such as, for example, a screwdriver.

For the dismounting, an auxiliary tool (not illustrated), can be inserted into the cutout 21 in the mounting tool 18′. As an auxiliary tool, use may be made for example of a screwdriver, in particular a flat-tipped screwdriver. Here, the tip of the screwdriver is pushed into the cutout 21 between the lug 22 and the edge of the end section 8b of the pad retaining clip 8, and the mounting tool 18′ is released by way of a lever movement in the y direction (see FIG. 7).

An abutment 23a protects the securing element 11 against bending during transportation, during handling and in the operating state.

An additional abutment 23b protects the securing element 11 against spreading during transportation, during handling and in the operating state.

An axial abutment 23c abuts against a guide slot 26a in the respective lug section 12a of the securing element 11 during mounting/dismounting.

A run-on bevel 24 yields a defined initial resistance during mounting/dismounting. Furthermore, the run-on bevel 24 prevents inadvertent opening in the operating state.

An opening bevel 25 is provided in each case at an outer edge of a transition of each plate section 18′b to the transverse section 18′a in order to spread the securing element 11 for dismounting purposes.

Sections 26 are on two opposite outer sides of the plate sections 18′b for the spreading of the securing element 11 with a defined spacing

A horizontal guide 27 on the plate sections 18′b of the mounting tool 18′ is horizontally guided in each case by the guide slot 26a in a respective lug section 12a of the securing element 11 (see FIG. 10).

An axial guide 28 is formed by virtue of said lug being folded over. In this way, the mounting tool 18′ can neither tilt nor rotate.

Furthermore, in each case one abutment 29 is provided at each rear end of a plate section 18′b in order to conduct the forces in the event of jolts into the pad rear plate 5a.

The exemplary embodiments described above do not restrict the invention. The invention may be modified within the scope of the appended claims.

### LIST OF REFERENCE DESIGNATIONS

1 Disc brake

2 Brake disc

2a Brake disc axis of rotation

3 Brake caliper

3a Application section

3b Reaction section

3c Connecting section

4, 5 Brake pad

4a, 5a Pad rear plate

5b Opening

5c Rear side

6, 7 Pad retaining spring

8 Pad retaining clip

8a, 8b End section

9 Bearing section

9a Retaining section

10 Securing apparatus

11 Securing element

11a Body

11′a Face plate

11b Section

11c Connection

12 Spring arm

12a Lug section

12b Lug

12c Bevel

12d Face edge

12e Inner side

12f, 12g Longitudinal edge

13 Mounting tool

13a Base plate

13b Inner longitudinal wall

13c Outer longitudinal wall

13d Receptacle

13e, 13f Post

13g Outer surface

13h Detent surface

14 Finger plate

14a Bevel

115 Finger

15a Bevel

16, 17 Transverse edge

18, 18′ Mounting tool

18a, 18′a, 18″a Transverse member

18b, 18′b Plate section

18c Bevel

18d Recess

18e Spacing

19 Side wall

19a, 19c, 19f Guide plate

19b Bevel

19d, 19e Face edge

19g Detent surface

20 Abutment surface

R Rear side

Z Application side

x, y, z Coordinates

21 Cutout

22 Lug

23a, 23b, 23c Abutment

24 Run-on bevel

25 Opening bevel

26 Section

26a Guide slot

27 Horizontal guide

28 Axial guide

29 Abutment

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A mounting tool for mounting and/or dismounting of a pad retaining clip on a securing apparatus of a disc brake, wherein the securing apparatus has a securing element which is fixedly connected to a rear-side pad carrier plate of a rear-side brake pad of an associated disc brake, which securing element has at least two spring arms, the mounting tool comprising:
a base;
a spreading device; and
a guide device, by which the pad retaining clip is mountable or dismountable on the securing apparatus.

2. The mounting tool according to claim 1, wherein
the base has a base plate to which two finger plates with, in each case, one bevel are attached and form the spreading device.

3. The mounting tool according to claim 2, wherein
the guide device comprises two fingers with, in each case, one oblique surface, and
the two fingers are arranged on the base plate above the two finger plates.

4. The mounting tool according to claim 3, wherein
the oblique surfaces point toward the two finger plates.

5. The mounting tool according to claim 4, wherein
the mounting tool further comprises a retaining device.

6. The mounting tool according to claim 1, wherein
the mounting tool further comprises a retaining device.

7. The mounting tool according to claim 6, wherein
the retaining device comprises in each case one inner longitudinal wall and one outer longitudinal wall within each case one receptacle.

8. The mounting tool according to claim 7, wherein
the one inner longitudinal wall and one outer longitudinal wall on each longitudinal side of the base plate are arranged parallel to one another with a spacing, and
the one receptacle is arranged between the one inner longitudinal wall and one outer longitudinal wall.

9. The mounting tool according to claim 1, wherein
the base has a transverse member to which two plate sections with, in each case, one bevel are attached and form the spreading device.

10. The mounting tool according to claim 9, wherein
the guide device comprises in each case one side wall with guide sections which are each attached to a plate section.

11. The mounting tool according to claim 9, wherein
the guide device has in each case one horizontal guide on in each case one plate section.

12. The mounting tool according to claim 10, wherein
the mounting tool further comprises a retaining device.

13. The mounting tool according to claim 11, wherein
the mounting tool further comprises a retaining device.

14. The mounting tool according to claim 12, wherein
the retaining device is formed from the guide device with the side walls with guide sections.

15. The mounting tool according to claim 13, wherein
the retaining device is formed from the guide device with the side walls with guide sections.

16. The mounting tool according to claim 12, wherein
the retaining device has abutments and axial guides.

17. A disc brake for a vehicle having a brake disc with a brake disc axis of rotation, comprising:
a brake caliper with an application section and a rear section;
at least two brake pads with in each case one pad rear plate equipped with a pad retaining spring, which brake pads are supported in each case under preload of a pad retaining clip detachably fastened to the brake caliper, and of which brake pads an application-side brake pad is assigned to the application section and a rear-side brake pad is assigned to the rear section; and
a securing apparatus for securing the position of the pad retaining clip, wherein
the securing apparatus has a securing element which is fixedly connected to the rear-side pad carrier plate of the rear-side brake pad and which has two spring arms which engage with in each case one end section of the pad retaining clip, and
a mounting tool arranged on the securing element of the securing apparatus.

18. The disc brake according to claim 17, wherein
the mounting tool comprises a base; a spreading device; and a guide device, by which the pad retaining clip is mountable or dismountable on the securing apparatus.

19. A brake pad set for a disc brake having a brake disc with a brake disc axis of rotation, a brake caliper with an application section and a rear section, the brake pad set comprising:
at least two brake pads with, in each case, one pad rear plate equipped with a pad retaining spring;
a pad retaining clip by which the brake pads are supported in each case under preload of the pad retaining clip detachably fastened to the brake caliper, and of which brake pads an application-side brake pad is assigned to the application section and a rear-side brake pad is assigned to the rear section;
a securing apparatus for securing the position of the pad retaining clip, wherein the securing apparatus has a securing element which is fixedly connected to the rear-side pad carrier plate of the rear-side brake pad and which has two spring arms which engage with in each case one end section of the pad retaining clip; and
at least one mounting tool.

20. The brake pad set according to claim 19, wherein
the mounting tool comprises a base; a spreading device; and a guide device, by which the pad retaining clip is mountable or dismountable on the securing apparatus.
